(19) United States
(12) Patent Application Publication
(10) Pub. No.: US 2026/0102953 A1
(43) Pub. Date: Apr. 16, 2026

(54) CLEANING OF AN INJECTION MOLDING TOOL

(71) Applicant: MHT Mold & Hotrunner Technology AG, Hochheim (DE)

(72) Inventors: Christian Tilsner, Weiterstadt (DE); Dominik van der Velde, Hofheim (DE); Peter Süß, Hochheim (DE)

(21) Appl. No.: 19/357,690

(22) Filed: Oct. 14, 2025

(30) Foreign Application Priority Data
Oct. 15, 2024 (DE) 10 2024 129 943.6
Nov. 1, 2024 (DE) 10 2024 131 951.8

(51) Int. Cl. B29C 45/17; B29C 45/34

(52) U.S. Cl. CPC B29C 45/1753; B29C 45/34

(57) ABSTRACT

An injection molding tool for producing at least one molded part in a mold cavity, the injection molding tool having at least two tool elements which are movable relative to one another between an open position and a closed position and which are in contact with one another so as to form at least one vent gap. In the closed position the mold cavity is enclosed at least in sections by the at least two tool elements and the vent gap is connected to the mold cavity in such a way and has a cross section such that the vent gap permits venting of the mold cavity and prevents escape of a plasticized melt from the mold cavity. In the open position a molded part produced in the mold cavity can be removed from the injection molding tool. Also included is a method for cleaning an injection molding tool of the aforementioned type.

The present invention relates to an injection molding tool for producing at least one molded part in a mold cavity, the injection molding tool having at least two tool elements which are movable relative to one another between an open position and a closed position and which are in contact with one another so as to form at least one vent gap, wherein in the closed position the mold cavity is enclosed at least in sections by the at least two tool elements and the vent gap is connected to the mold cavity in such a way and has a cross section such that the vent gap permits venting of the mold cavity and prevents escape of a plasticized melt from the mold cavity, and wherein in the open position a molded part produced in the mold cavity can be removed from the injection molding tool. The present application also relates to a method for cleaning an injection molding tool of the aforementioned type.

Injection molding is one of the most important processes for producing plastic molded parts. In this process, the molding material, which generally initially exists as a powder or granulate, is heated, plasticized and, as plasticized melt, pressed under high pressure into a mold cavity of a corresponding injection molding tool. The molding material solidifies in the injection molding tool and is then removed from the opened injection molding tool as a molded part. The molded part may be a finished molded part or a preform which is then reworked in a further process step. For example, commercially available PET bottles are produced by stretch-blow molding of a hollow-body preform.

To produce a molded part, an injection molding tool typically comprises a cavity plate having at least one cavity insert and a core plate having at least one mold core, the cavity plate and the core plate being movable relative to one another so that they can be moved back and forth between an open position and a closed position. In the closed position, the mold core is arranged in the cavity insert so that a mold cavity is formed in which the plasticized melt is introduced. An inner contour of the cavity insert corresponds at least in sections to the outer contour of the molded part to be produced, while an outer contour of the mold core corresponds at least in sections to the inner contour of the molded part to be produced. In the open position, by contrast, the mold core is not arranged in the cavity insert so that the solidified molded part can be removed from the injection molding tool.

An injection molding tool often furthermore has a so-called core ring which surrounds the mold core and delimits the mold cavity towards the core plate. The core ring and the mold core may be formed in one piece or as two separate components.

In addition, a typical injection molding tool often has a neck ring, which serves to exactly position the mold core in the cavity insert in the closed position and closes off the mold cavity. For this purpose, the neck ring is arranged along a longitudinal axis of the injection molding tool between the cavity plate and the core plate in such a way that it complements the assembly of cavity insert and mold core. An inner contour of the neck ring here corresponds to a section of the outer contour of the molded part to be produced and thus likewise forms a part of the mold cavity for the plasticized melt.

In the production of PET bottles, for example, the neck ring forms a thread section of the later PET bottle. Due to undercuts, such a thread section can be removed from the injection molding tool only if the tool which forms it, i.e. the neck ring, is of multipart design. For this purpose, the neck ring typically consists of two so-called neck halves which in the closed position are in contact with one another and close off the mold cavity. In the open position of the injection molding tool, by contrast, the neck halves can be moved apart so that the molded part produced can be removed. Tool elements within the meaning of the present invention therefore include, in addition to the mold core and the cavity insert, for example also neck halves of an injection molding tool.

To produce a molded part, the neck halves of the neck ring are first brought into contact with one another and then the mold core is arranged with the neck halves in the cavity so that a closed mold cavity is created which withstands the injection pressure of the plasticized melt. This arrangement is an closed position of the injection molding tool within the meaning of the present invention. Once the melt has sufficiently solidified, the neck halves are moved apart again and the mold core is moved out of the cavity insert so that the molded part can be removed. This arrangement is an open position of the injection molding tool within the meaning of the present invention.

The process steps mentioned, which describe one production cycle of a molded part, are typically carried out within a few seconds, so that a production cycle is repeated many times within a very short time. During each production cycle, small particles of the molding material may remain in the injection molding tool, in particular in gaps between the tool elements of the tool which do not come into direct contact with the melt, and these can become clogged over time. In addition, small particles may also enter the gaps during the injection molding operation through venting of the mold cavity.

Such a gap is located, for example, between the support ring and the neck ring, between the cavity insert and the neck ring, between the neck ring and the mold core, between the core ring and the neck ring, between the core ring and the mold core if these are designed as separate components, or between the neck halves of the neck ring, and is configured in such a way that in the closed position of the tool it allows no melt to escape from the mold cavity, but serves for venting the mold cavity. Clogging of this gap, which can also be referred to as a vent gap, therefore leads to the medium-or long-term inability of air to escape from the mold cavity and the injection molding process is impaired.

A cleaning of the injection molding tool, in particular of the vent gaps between the tool elements, is therefore required. However, manual cleaning is cumbersome and leads to high downtimes of the injection molding tool.

Various possibilities for cleaning an injection molding tool are known from the prior art. One possibility for cleaning consists, for example, in targeted over-molding of the mold cavity. For this purpose, the tool elements are arranged in a cleaning position in which the tool elements are spaced further apart than in the closed position. Melt is introduced into this resulting enlarged mold cavity, which can also penetrate into the vent gaps between the tool elements which are enlarged in the cleaning position. Small dirt particles which have accumulated in the gaps can adhere to the melt and be removed together with the solidified molded part. The molded parts produced in these cleaning cycles are then discarded. For this targeted over-molding, either special machine control can be used or additional spacers are arranged between the tool elements which prevent plasticized melt from flowing out.

In any case, the targeted over-molding of the mold cavity is associated with additional control and assembly effort, so that cleaning of the injection molding tool in this variant likewise entails corresponding production downtime.

The object underlying the present invention is therefore to provide an injection molding tool and a cleaning method for an injection molding tool, with which a most complete and preferably simultaneous cleaning of all vent gaps is ensured in a simple manner without additional components.

The object underlying the invention is achieved by an injection molding tool of the type mentioned at the outset, wherein the injection molding tool further has a cleaning structure, the cleaning structure being arranged and configured in such a way that a cleaning fluid, preferably compressed air, can be routed via the cleaning structure into the at least one vent gap between the tool elements.

According to the invention, it is therefore envisaged that a cleaning fluid penetrates via a cleaning structure into at least one vent gap or, preferably, into several vent gaps simultaneously in order to remove adhering dirt particles.

This offers the advantage that the cleaning fluid comes into contact with all gaps between the tool elements of the injection molding tool and thus the injection molding tool is cleaned as completely as possible.

The cleaning structure is configured and arranged in such a way that it is ensured that in the closed position no plasticized melt can escape from the mold cavity. The cleaning structure is therefore separated from the mold cavity by the at least one vent gap. In the closed position of the tool elements, the vent gap has a cross section which ensures that only air can escape from the mold cavity, but no melt can escape.

In one embodiment, adjacent sections of the at least two tool elements are arranged one behind the other in a radial direction about a longitudinal axis of the injection molding tool in such a way that a distribution channel is formed between the at least two tool elements, which extends at least in sections about the longitudinal axis of the injection molding tool and connects a supply channel of the cleaning structure to the at least one vent gap. In other words, a section of one tool element surrounds a section of the other tool element in the circumferential direction. The distribution channel does not necessarily have to have a constant cross section and also does not necessarily have to be formed fully circumferentially. Preferably, however, the adjacent sections of the tool elements are arranged concentrically about the longitudinal axis and/or the distribution channel is of annular design. The distribution channel ensures that the cleaning fluid can penetrate the vent gaps between the tool elements as simultaneously as possible and that a corresponding flow dynamic arises which is suitable for particularly effectively entraining the dirt particles.

Tool elements within the meaning of the present invention are, for example, cavity inserts of a cavity plate, mold cores of a core plate, neck halves of a neck ring of an injection molding tool, support rings or core rings.

In one embodiment, the injection molding tool therefore has as tool elements a cavity insert, a mold core with a core ring, a neck ring and a support ring, the core ring partially surrounding a rear section of the mold core along the longitudinal axis of the injection molding tool, the support ring partially surrounding the core ring and the rear section of the mold core along the longitudinal axis, the neck ring surrounding a middle section of the mold core along the longitudinal axis, a front section of the mold core being arranged in the cavity insert in the closed position, so that the mold cavity is formed by the cavity insert, the front section of the mold core, the core ring and the neck ring, a first vent gap being formed between the core ring and the neck ring, and a third vent gap being formed between the neck ring and the cavity insert, a distribution channel of the cleaning structure being formed between the neck ring and the core ring, the distribution channel adjoining the first vent gap so that the cleaning fluid can be routed via the distribution channel and the first vent gap into the mold cavity or vice versa, the core ring and the mold core preferably being designed as separate tool elements and a second vent gap being formed between the core ring and the mold core.

The core ring and the mold core may thus, in one embodiment, be formed in one piece so that no vent gap is formed between the core ring and the mold core, or the mold core and the core ring are designed as separate tool elements so that the second vent gap forms between the two tool elements. The second vent gap is likewise connected to the mold cavity. In one embodiment, the neck ring can also be of two-part design and consist of two neck halves which are movable relative to one another. A fourth vent gap is then formed between the neck halves.

In a further embodiment, the distribution channel is connected to the second vent gap via an auxiliary channel so that the cleaning fluid can be routed via the distribution channel, the first vent gap and the second vent gap into the mold cavity or vice versa.

In particular, in one embodiment the supply channel for the cleaning fluid is formed in the support ring, a recess being formed preferably in an end face of the neck ring which faces the support ring and/or in an end face of the support ring which faces the end face of the neck ring, which recess forms a connection between the distribution channel and the supply channel. The recess serves primarily to guide a fluid flow of the cleaning fluid, which is introduced from the supply channel, into the distribution channel. For this purpose, the recess in the end face need not be of circumferential design. Rather, it is sufficient if one or two recesses are formed as pockets in the end face of the neck ring and/or the end face of the support ring, which respectively adjoin a supply channel for the cleaning fluid.

In a further embodiment, at least one supply channel of the cleaning structure is formed in the cavity insert. It is understood that the supply channel of the cleaning structure can be formed exclusively in the cavity insert, or in addition to a supply channel via the support ring or the mold core, a supply channel via the cavity insert can also be provided. For example, the cleaning fluid can enter from the supply channel in the support ring or mold core via the distribution channel and the at least one vent gap between the neck ring and the core ring into the mold cavity and be discharged again via the third vent gap and the supply channel in the cavity insert, or vice versa.

Overall, various possibilities exist for realizing the supply of the cleaning fluid into the vent gap and the mold cavity. The cleaning structure according to the invention is thus independent of the type of tool used. In particular, cleaning can be effected either by supplying cleaning fluid into the vent gaps or, alternatively, extraction of dirt particles via the cleaning structure is also conceivable.

In a further embodiment, in addition to the open position and the closed position, the tool elements can be arranged in a cleaning position, in which cleaning position the at least one vent gap between the tool elements is smaller than in the open position and larger than in the closed position, so that an enlarged mold cavity is formed between the tool elements, the cleaning fluid being routable with the cleaning structure into the enlarged mold cavity. By enlarging the vent gap between the tool elements, the cleaning fluid can better penetrate between the tool elements and thus entrain dirt particles more effectively.

In particular, in a further embodiment the injection molding tool has, as tool elements, a cavity insert, a mold core and a neck ring, the neck ring partially surrounding the mold core along the longitudinal axis, a front section of the mold core being arranged in the cavity insert in the closed position so that the mold cavity is formed by the cavity insert, the front section of the mold core and the neck ring, a first vent gap being formed between the neck ring and a rear section of the mold core which does not form a section of the mold cavity, and a second vent gap being formed between the neck ring and the cavity insert, the first vent gap between the neck ring and the rear section of the mold core being formed as the distribution channel of the cleaning structure when the tool elements are arranged in the cleaning position, so that the cleaning fluid can be routed via the first vent gap as the distribution channel into the enlarged mold cavity or vice versa, the supply channel preferably being formed in the rear section of the mold core.

The object underlying the invention is further achieved by a method for cleaning an injection molding tool according to one of the embodiments described above, the method comprising the following steps:
a. arranging the tool elements in the closed position,
b. injecting a molding mass into the mold cavity to form the molded part,
c. moving the tool elements into the open position and removing the molded part,
   wherein during step a. and/or during step c. a cleaning-fluid pulse is initiated via the cleaning structure into the at least one vent gap.

It is preferable to supply the cleaning fluid at the point in time when the tool elements begin to move into the open position, i.e. when the tool elements are still arranged in the closed position but the molded part has sufficiently solidified to be removed. Cleaning thus takes place temporally together with removal of the molded part.

By supplying the cleaning fluid while the tool elements are still arranged in the closed position, a flow dynamic of the cleaning fluid is achieved which particularly effectively entrains the dirt particles. Thus, an appropriate pressure of the cleaning fluid is first built up in the cleaning structure when, at the beginning of step c., the tool elements are still arranged in the almost closed position. If the tool elements are then preferably moved apart abruptly, a pressure pulse arises from the cleaning structure into the vent gap and the mold cavity and thus into further associated vent gaps, which effectively entrains the dirt particles.

In a further embodiment, after removal of the molded part the tool elements are arranged for a certain period in a cleaning position in which the tool elements have a spacing which is greater than a spacing of the tool elements in the closed position and smaller than a spacing of the tool elements in the open position, the duration preferably being at least 0.1 seconds and at most 1.5 seconds. In other words, the tool elements of the injection molding tool are arranged for a certain time in the cleaning position; the movement from the open position to the closed position is thus interrupted for a certain time.

By virtue of the design of the cleaning method according to the invention and the associated simultaneous cleaning of several vent gaps, a very short duration in the cleaning position is already sufficient to clean the elements of the injection molding tool. This results in lower consumption of cleaning fluid. In particular in the case of a cleaning fluid in the form of compressed air, costs can thus be saved.

In a further embodiment, steps a. to c. are repeated in successive cycles and the cleaning-fluid pulse takes place during each pass of step a. and/or c. Only a few dirt particles can accumulate within one production cycle, so that a correspondingly short cleaning-fluid pulse is sufficient. At the same time, due to the short duration of the cleaning, the method of producing the molded parts is not significantly affected in time.

In a further embodiment, the cleaning-fluid pulse supports removal of the molded part. In particular, structures for blow-off air already present in the injection molding tool can be used to achieve the cleaning of the injection molding tool according to the invention. Thus, for example, the supply channel of the venting structure can at the same time be the channel already present for the blow-off air.

It is understood that embodiments described with regard to the injection molding tool can also be transferred to the method for cleaning the injection molding tool, and vice versa.

Further advantages, features and possible applications of the present invention will become clear with reference to the following description of various embodiments. Identical components are identified with the same reference numerals.

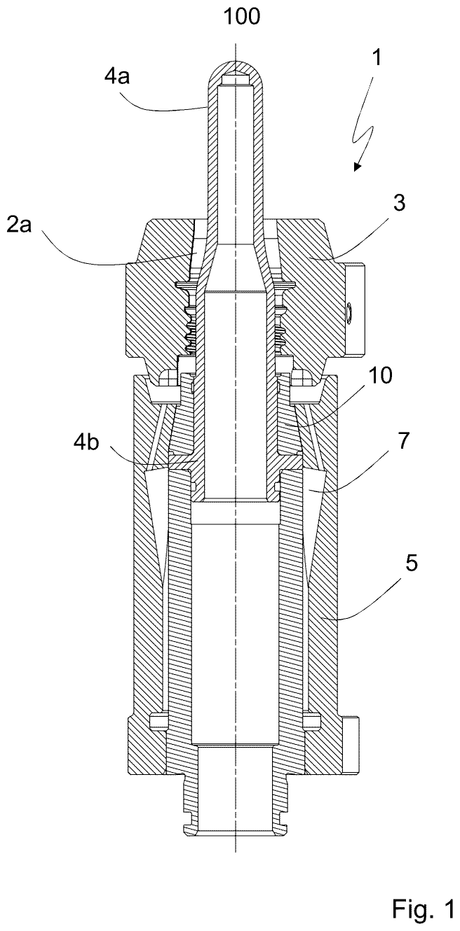

FIG. 1 shows a schematic cross-section through a first embodiment of the injection molding tool according to the invention in the cleaning position.

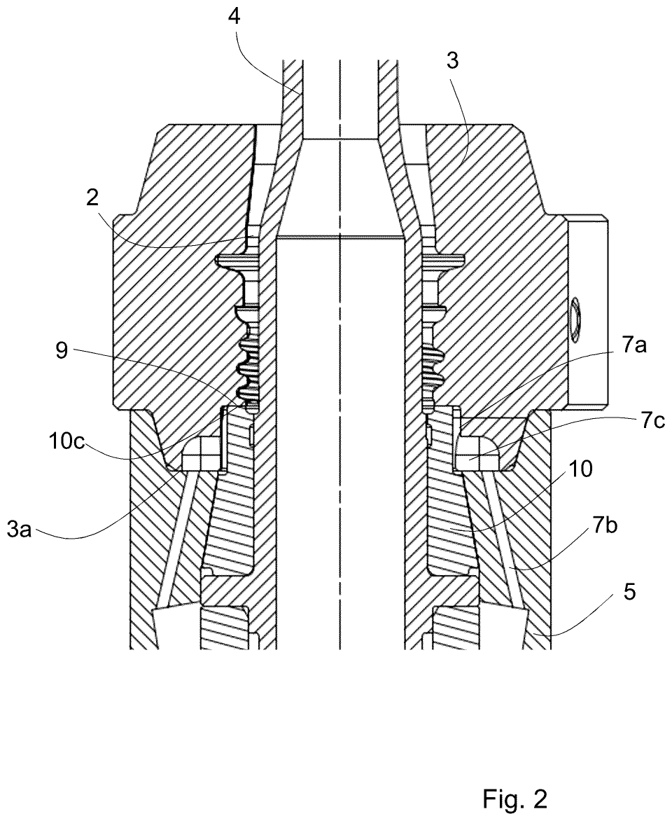

FIG. 2 shows an enlargement of the first embodiment shown in FIG. 1 in the closed position.

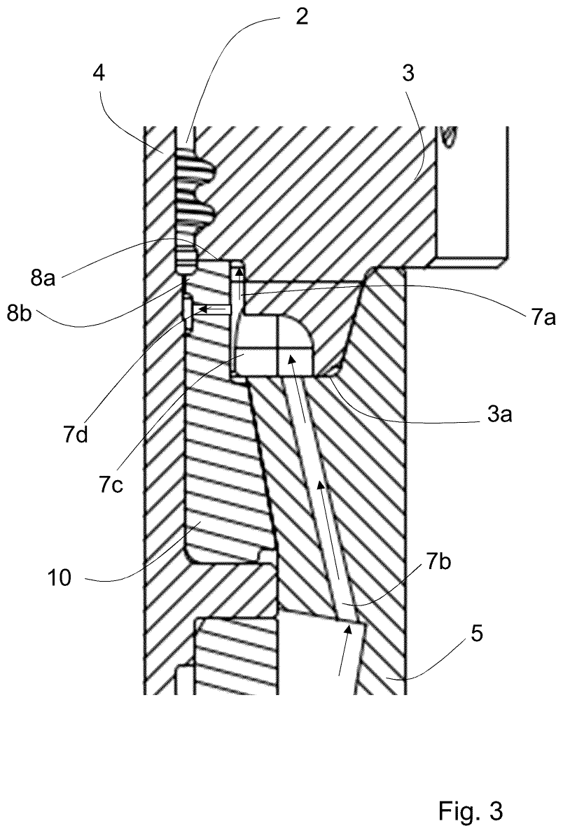

FIG. 3 shows a further enlargement of the first embodiment shown in FIG. 2.

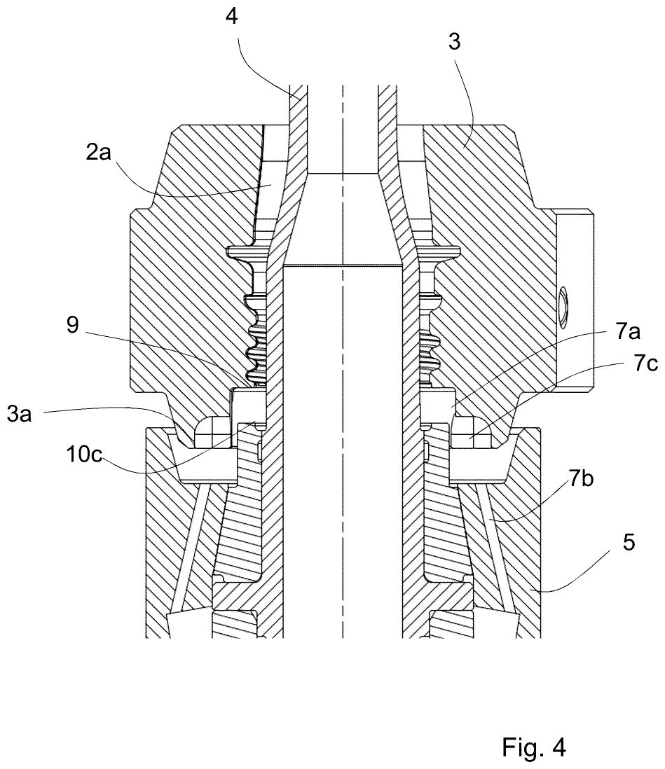

FIG. 4 shows the first embodiment shown in FIG. 2 in a cleaning position.

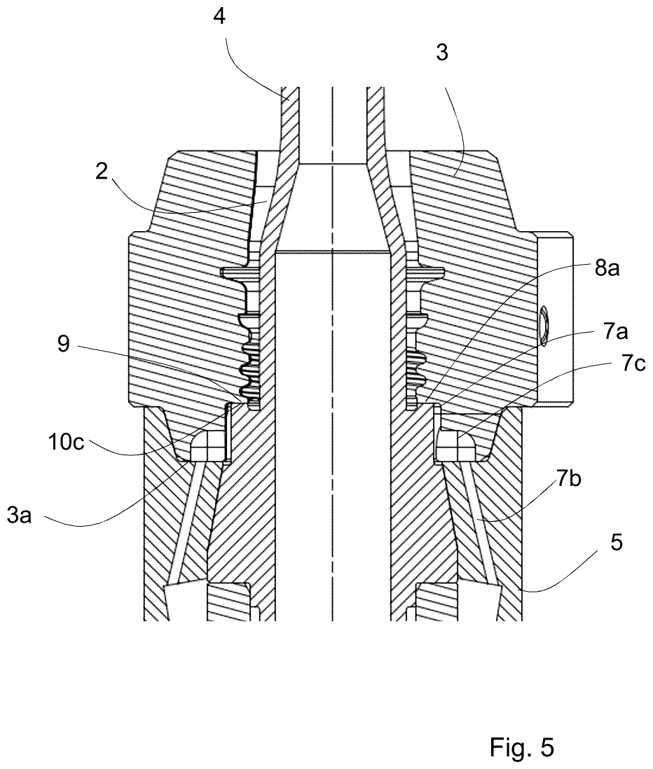

FIG. 5 shows a detail of a schematic cross-section through a second embodiment of the injection molding tool according to the invention in the closed position.

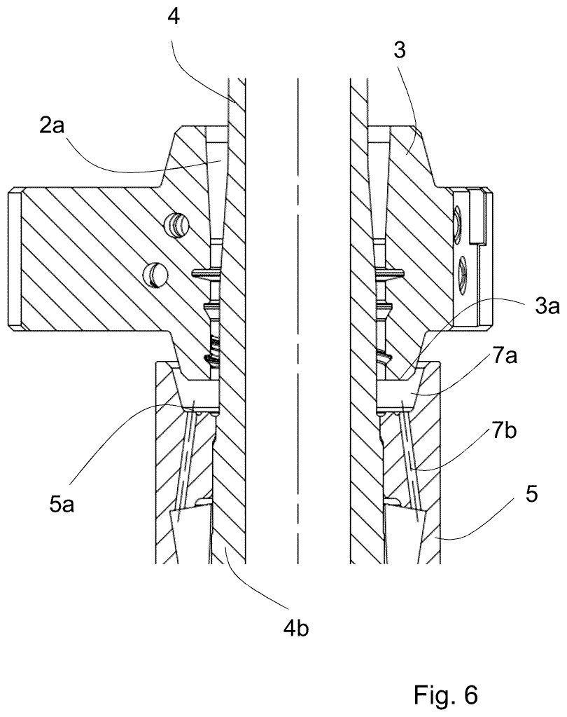

FIG. 6 shows a detail of a schematic cross-section through a third embodiment of the injection molding tool according to the invention.

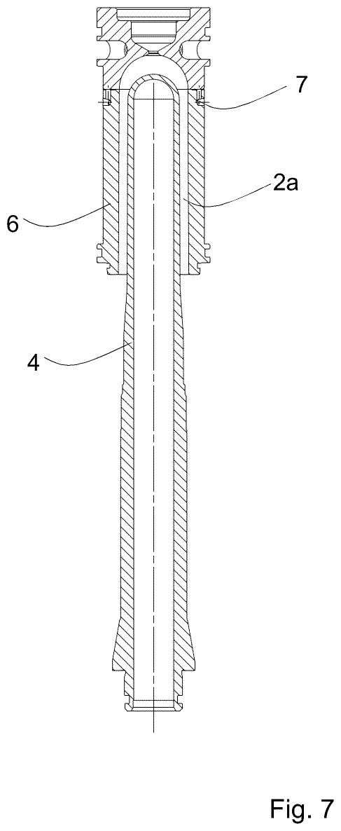

FIG. 7 shows a schematic cross-section through a fourth embodiment of the injection molding tool according to the invention in the cleaning position.

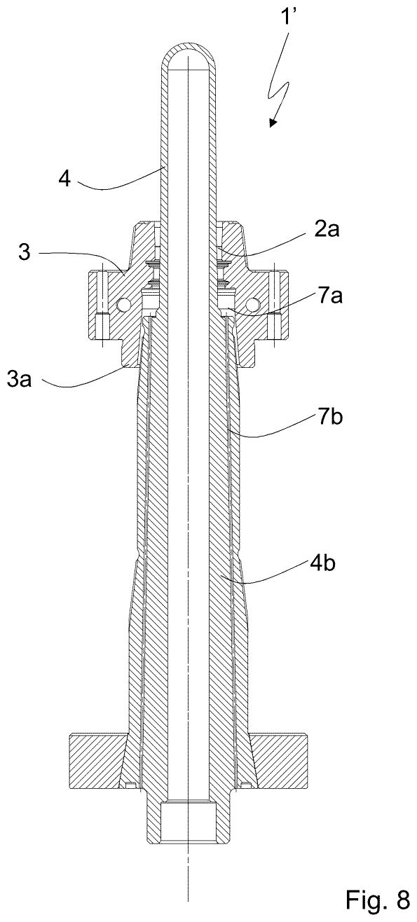

FIG. 8 shows a schematic cross-section through a fifth embodiment of the injection molding tool according to the invention in the cleaning position.

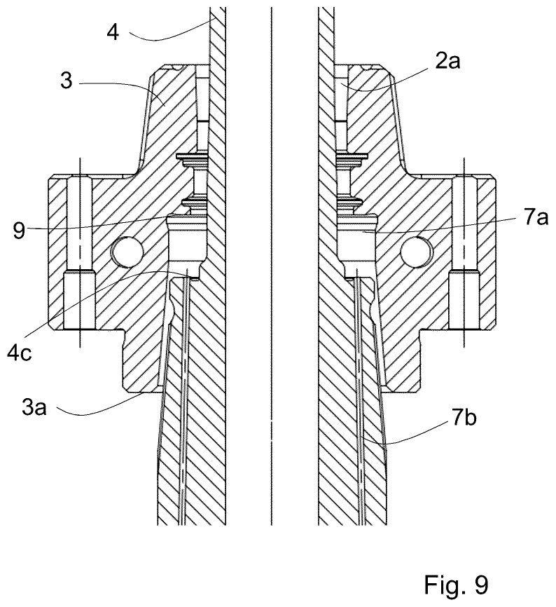

FIG. 9 shows an enlargement of the fifth embodiment shown in FIG. 7.

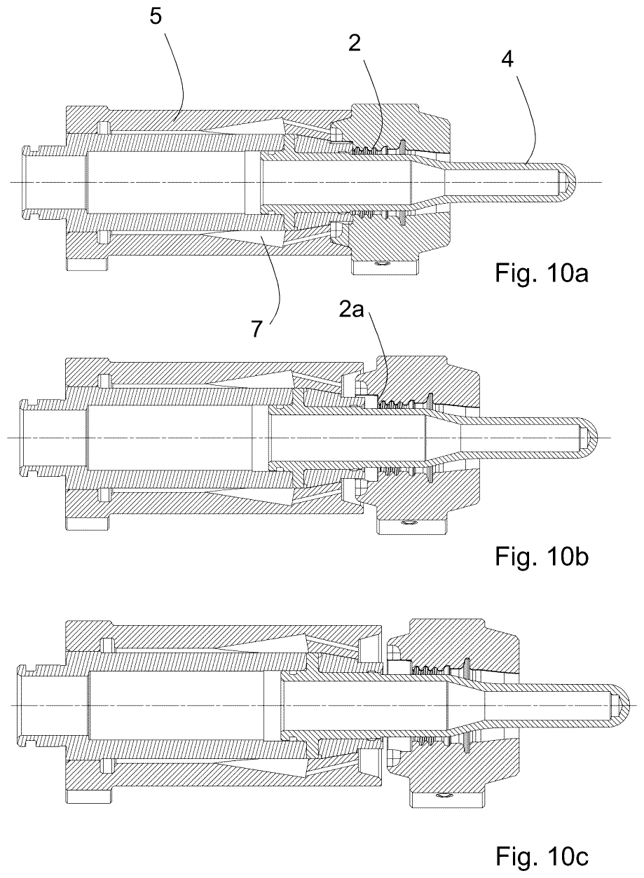

FIG. 10a shows a schematic cross-section through the first embodiment of the injection molding tool according to the invention in the closed position.

FIG. 10b shows a schematic cross-section through the first embodiment of the injection molding tool according to the invention in the cleaning position.

FIG. 10c shows a schematic cross-section through a first embodiment of the injection molding tool according to the invention in the open position.

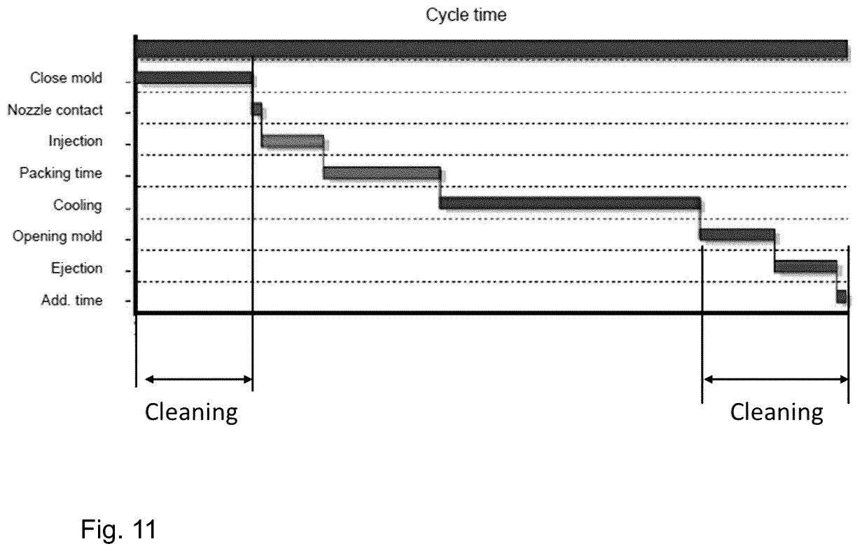

FIG. 11 shows a flow diagram for one embodiment of the method according to the invention.

All the embodiments shown have in common that they comprise, as tool elements, a mold core 4 and a neck ring 3 and a cavity insert 6. The mold core 4 is arranged on a core plate (not shown) and has a front section 4a which forms an inner contour of the molded part to be produced and delimits the mold cavity 2 in sections. The mold cavity 2 is further delimited by the neck ring 3, which may consist, for example, of two neck halves. In the embodiments shown, an inner contour of the neck ring 3 forms, for example, a thread section of the molded part to be produced. In addition, in all embodiments a cavity insert 6 is provided in which the front section 4a of the mold core 4 is arranged in the closed position (see FIG. 7) and which defines an outer contour of the molded part to be produced. In FIGS. 1 to 5 and 7 to 10, the cavity insert 6 has been omitted only for the sake of clarity.

In the embodiments shown, the cavity insert 6, the front section 4a of the mold core 4 and the neck ring 3 form a mold cavity 2 in the closed position (see FIGS. 2, 3, 5 and 10a) and an enlarged mold cavity 2a in the cleaning position (see FIGS. 1, 6, 7, 8, 9, 10b), the mold cavity 2 differing from the enlarged mold cavity 2a primarily in that a spacing between the tool elements is so small that no plasticized melt can escape from the mold cavity 2.

In the first embodiment shown in FIGS. 1 to 4 and 10a to 10c, a rear section 4b of the mold core 4 is additionally surrounded by a separate core ring 10 and by a support ring 5, an end face 10c of the core ring 10 likewise delimiting the mold cavity 2 towards the core plate. The support ring 5 serves for fastening the mold core 4 to the core plate. A supply channel 7b of a cleaning structure 7 is provided in the support ring 5, the cleaning structure furthermore consisting of a distribution channel 7a and a pocket-shaped recess 7c. The distribution channel 7a is arranged as an annular channel between the core ring 10 and the neck ring 3, which are arranged concentrically about the longitudinal axis 100, and adjoins directly a first vent gap 8a between the neck ring 3 and the end face 10c of the core ring 10. Furthermore, the annular distribution channel 7a is connected via an auxiliary channel 7d to a second vent gap 8b between the mold core 4 and the core ring 10. The pocket-shaped recess 7c is arranged in an end face 3a of the neck ring 3 which faces the core plate and forms a connection between the distribution channel 7a and the supply channel 7b.

If the injection molding tool 1 is in the closed position, as shown in FIGS. 2, 3 and 10a, a projection 9 of the neck ring 3 is in contact with the end face 10c of the core ring 10. This closes off the mold cavity 2 towards the core plate in the closed position so that no plasticized melt can escape from the mold cavity 2. The first vent gap 8a is arranged between the projection 9 and the end face 10c.

In order to clean the vent gaps 8a and 8b simultaneously, preferably while still in the closed position cleaning fluid, e.g. compressed air, is routed via the supply channel 7b first into the pocket-shaped recess 7c and from there via the annular distribution channel 7a into the first vent gap 8a and additionally via the auxiliary channel 7d into the second vent gap 8b. This entrains dirt particles from the vent gaps 8a and 8b and discharges them via the mold cavity and further vent gaps between the neck ring 3 and the cavity insert 6 or a supply channel in the cavity insert 6.

If the neck ring 3 and the mold core 4 are moved apart in the direction of the open position (see FIGS. 4, 10b and 10c), the distribution channel 7a is moved along the core ring 10 in the direction of the longitudinal axis 100 in such a way that an enlarged connection is created between the supply channel 7b and the enlarged mold cavity 2a via the distribution channel 7a and the recess 7c. If the tool elements 3, 4, 5, 6 and 10 are spaced further apart than in the closed position, an enlarged mold cavity 2a is also referred to, since the volume of the enlarged mold cavity 2a is greater than in the closed position due to the greater spacings of the tool elements 3, 4, 5, 6 and 10.

The second embodiment shown in FIG. 5 essentially corresponds to the first embodiment, the core ring 10 and the mold core 4 being of one-piece design so that there is no second vent gap between the core ring 10 and the mold core 4. In this embodiment, the cleaning fluid therefore first passes via the supply channel 7b into the pocket-shaped recess 7c and from there via the annular distribution channel 7a into the first vent gap 8a between the core ring 10 of the mold core 4 and the neck ring 3.

The third embodiment shown in FIG. 6 differs from the first and second embodiments in that no recess is provided in the end face 3a of the neck ring 3. The cleaning structure 7, which is likewise provided in the support ring 5, thus impinges directly on the end face 3a of the neck ring 3. This ensures that no plasticized melt can penetrate into the cleaning structure 7 when the tool elements 3, 4, 5 and 6 are arranged in the closed position, i.e. when the end face 3a of the neck ring 3 is in direct contact with an end face 5a of the support ring 5. The end face 5a of the support ring 5 is preferably provided, as shown in FIG. 5, with a recess into which a projection of the neck ring 3, which has the end face 3a, engages in the closed position and also in the cleaning position. In the cleaning position shown in FIG. 5, however, the neck ring 3 has already been moved a short distance along the longitudinal axis 100 away from the rear section 4b of the mold core 4 and the support ring 5, as a result of which the vent gap between the end face 3a of the neck ring and the end face 5a of the support ring 5 forms an annular distribution channel 7a via which the cleaning fluid is routed through the supply channel 7b into the enlarged mold cavity 2a.

In the fourth embodiment shown in FIG. 7, the air supply 7 is provided in a cavity insert 6. The remaining configuration of the mold core 4, the support ring 5 and the neck ring 3 can be provided just as in the embodiments discussed above.

The fifth embodiment shown in FIGS. 8 and 9 differs from the other embodiments primarily in that the supply channel 7b of the cleaning structure 7 is provided in the rear section 4b of the mold core 4 and not in a support ring 5. In this embodiment, too, the neck ring 3 has, in the passage for the mold core 4, a projection 9 which, in the closed position, is brought into contact with a shoulder section 4c of the mold core in order to close off the mold cavity 2 towards the core plate and ensure that no plasticized melt can penetrate into the cleaning structure 7. The supply channel 7b of the cleaning structure 7 has an opening in the shoulder section 4c and thus supplies cleaning fluid into a distribution channel 7a which is likewise formed annularly about the longitudinal axis 100 and arises as soon as the tool elements 3 and 4 are moved in the direction of the open position. The cleaning fluid is then routed via the distribution channel 7a into the enlarged mold cavity 2a.

In FIGS. 10a-10c and FIG. 11, a sequence of the method according to the invention is shown. Although the sequence of the method is described using the first embodiment, it is understood that the sequence of the method can also be applied directly to the other embodiments.

First, the injection molding tool 1 is in the closed position shown in FIG. 10a. In this case, the end face 10c of the core ring 10 is in engagement with the projection 9 of the neck ring 3. In this state, the plasticized melt is introduced into the mold cavity 2. Air can escape from the mold cavity 2 through the vent gaps formed between the tool elements 3, 4, 5, 6 and 10, so that the mold cavity 2 is vented and the plasticized melt can distribute itself uniformly in the mold cavity 2.

As soon as the molded part in the mold cavity 2 has sufficiently solidified, the cleaning method is initiated, for which cleaning fluid, preferably compressed air, is supplied through the supply channel 7b and the annular distribution channel 7a of the cleaning structure 7. Preferably, the cleaning process is started when the tool elements 3, 4, 5, 6 and 10 are still in the closed position and/or the cleaning takes place simultaneously with the moving apart of the tool elements 3, 4, 5, 6 and 10.

In a next step, the molded part is removed from the injection molding tool 1 by moving the tool elements 3, 4, 5 and 10 into the open position shown in FIG. 10c. Removal of the molded part is supported by the pressure of the cleaning fluid which is routed through the cleaning structure 7 into the mold cavity 2.

After the molded part has been removed, the tool elements 3, 4, 5 and 10 are again arranged for a certain duration in the cleaning position shown in FIG. 10b and the enlarged mold cavity 2a formed there is further acted upon with cleaning fluid. The tool elements 3, 4, 5 and 10 are then returned to the closed position and a new injection molding operation is started.

In this way, a short cleaning of the vent gaps between the tool elements 3, 4, 5, 6 and 10 can take place after each injection-molding cycle, so that the tool 1, 1′ does not become significantly clogged with dirt particles.

### REFERENCE SIGNS

1,1′ injection molding tool
2 mold cavity
2a enlarged mold cavity
3 neck ring
3a end face
4 mold core
4a front section
4b rear section
4c shoulder section of the mold core
5 support ring
5a end face
6 cavity insert
7 cleaning structure
7a distribution channel
7b supply channel
7c recess
7d auxiliary channel
8a first vent gap
8b second vent gap
9 projection
10 core ring
10c end face of the core ring
100 longitudinal axis

1. An injection molding tool for producing at least one molded part in a mold cavity, the injection molding tool comprising:
at least two tool elements which are movable relative to one another between an open position and a closed position and which are in contact with one another so as to form at least one vent gap, wherein in the closed position the mold cavity is enclosed at least in sections by the at least two tool elements and the vent gap is connected to the mold cavity in such a way and has a cross section such that the vent gap permits venting of the mold cavity and prevents escape of a plasticized melt from the mold cavity and wherein in the open position a molded part produced in the mold cavity can be removed from the injection molding tool; and
a cleaning structure the cleaning structure being arranged and configured such that a cleaning fluid can be routed via the cleaning structure into the at least one vent gap between the tool elements.

2. The injection tool according to claim 1, wherein adjacent sections of the at least two tool elements are arranged one behind the other in a radial direction about a longitudinal axis of the injection molding tool in such a way that a distribution channel is formed between the at least two tool elements, which extends at least in sections about the longitudinal axis of the injection molding tool and connects a supply channel of the cleaning structure to the at least one vent gap.

3. The injection molding tool according to claim 1, wherein the tool elements comprise:
a cavity insert,
a mold core with a core ring, the core ring partially surrounding a rear section of the mold core along the longitudinal axis of the injection molding tool,
a support ring partially surrounding the core ring and the rear section of the mold core along the longitudinal axis,
a neck ring surrounding a middle section of the mold core along the longitudinal axis,
wherein a front section of the mold core is arranged in the cavity insert in the closed position so that the mold cavity is formed by the cavity insert, the front section of the mold core, the core ring and the neck ring,
wherein a first vent gap is formed between the core ring and the neck ring and a third vent gap is formed between the neck ring and the cavity insert,
wherein a distribution channel of the cleaning structure is formed between the neck ring and the core ring, the distribution channel adjoining the first vent gap so that the cleaning fluid can be routed via the distribution channel and the first vent gap into the mold cavity or vice versa and
wherein a second vent gap is formed between the core ring and the mold core.

4. The injection molding tool according to claim 3, wherein the distribution channel is connected to the second vent gap via an auxiliary channel so that the cleaning fluid can be routed via the distribution channel, the first vent gap and the second vent gap into the mold cavity or vice versa.

5. The injection molding tool according to claim 3, wherein a supply channel for the cleaning fluid is formed in the support ring at least one recess being formed in an end face of the neck ring which faces the support ring and/or in an end face of the support ring which faces the end face of the neck ring, which recess forms a connection between the distribution channel and the supply channel.

6. The injection molding tool according to claim 2, wherein at least one supply channel of the cleaning structure is formed in the cavity insert such that the cleaning fluid can be routed via the supply channel into the mold cavity and from the mold cavity into at least the first and third vent gap, or vice versa.

7. The injection molding tool according to claim 1, wherein the tool elements in addition to the open position and the closed position, can be arranged in a cleaning position, in which cleaning position the at least one vent gap between the tool elements is smaller than in the open position and larger than in the closed position, so that an enlarged mold cavity is formed between the tool elements the cleaning fluid being routable with the cleaning structure into the enlarged mold cavity.

8. The injection molding tool according to claim 7,
wherein adjacent sections of the at least two tool elements are arranged one behind the other in a radial direction about a longitudinal axis of the injection molding tool in such a way that a distribution channel is formed between the at least two tool elements, which extends at least in sections about the longitudinal axis of the injection molding tool and connects a supply channel of the cleaning structure to the at least one vent gap.
wherein the as tool elements comprise:
a cavity insert
a mold core, and
a neck ring (3), the neck ring partially surrounding the mold core along the longitudinal axis,
wherein a front section of the mold core is arranged in the cavity insert in the closed position so that the mold cavity is formed by the cavity insert, the front section of the mold core and the neck ring,
wherein a first vent gap is formed between the neck ring and a rear section of the mold core which does not form a section of the mold cavity,
wherein a second vent gap is formed between the neck ring and the cavity insert,
wherein the first vent gap between the neck ring and the rear section of the mold core is formed as the distribution channel of the cleaning structure when the tool elements are arranged in the cleaning position, so that the cleaning fluid can be routed via the first vent gap as a distribution channel into the enlarged mold cavity or vice versa.

9. A method for cleaning the injection molding tool according to claim 1, the method comprising the following steps:
a. arranging the tool elements in the closed position,
b. injecting a molding mass into the mold cavity to form the molded part, and
c. moving the tool elements into the open position and removing the molded part,
wherein during step a. and/or during step c. a cleaning-fluid pulse is initiated via the cleaning structure into the at least one vent gap.

10. The method according to claim 9, wherein after removal of the molded part the tool elements are arranged for a certain duration in a cleaning position in which the tool elements have a spacing which is greater than a spacing of the tool elements in the closed position and smaller than a spacing of the tool elements in the open position.

11. The method according to claim 9, wherein steps a. to c. are repeated in successive cycles and the cleaning-fluid pulse takes place during each pass of step a. and/or c.

12. The method according to claim 9, wherein the cleaning-fluid pulse supports removal of the molded part.

13. The method according to claim 9, wherein adjacent sections of the at least two tool elements are arranged one behind the other in a radial direction about a longitudinal axis of the injection molding tool in such a way that a distribution channel is formed between the at least two tool elements, which extends at least in sections about the longitudinal axis of the injection molding tool and connects a supply channel of the cleaning structure to the at least one vent gap and,
wherein, with one cleaning-fluid pulse, several, vent gaps are cleaned simultaneously.

14. The injection molding tool according to claim 1, wherein the cleaning fluid is compressed air.

15. The injection molding tool according to claim 2, wherein the distribution channel extends at least in section annularly about the longitudinal axis of the injection molding tool.

16. The injection molding tool according to claim 3, wherein the core ring and the mold care are separate tool elements.

17. The injection molding tool according to claim 5, wherein the at least one recess is formed in the end face of the neck ring which faces the support ring.

18. The injection molding tool according to claim 8, wherein the supply channel is formed in the rear section of the mold core.

19. The method according to claim 10, wherein the duration is at least 0.1 seconds and at most 1.5 seconds.

20. The method according to claim 13, wherein, with one cleaning-fluid pulse, all vent gaps are cleaned simultaneously.
